(19) United States
(12) Patent Application Publication
(10) Pub. No.: US 2014/0280393 A1
(43) Pub. Date: Sep. 18, 2014

(54) CACHED DATA VALIDITY

(71) Applicant: APPLE INC., Cupertino, CA (US)

(72) Inventors: Dominic B. Giampaolo, Mountain View, CA (US); George C. Chicioreanu, Cupertino, CA (US)

(73) Assignee: APPLE INC., Cupertino, CA (US)

(21) Appl. No.: 13/834,044

(22) Filed: Mar. 15, 2013

(51) Int. Cl. G06F 17/30

(52) U.S. Cl. CPC G06F 17/30091
USPC 707/822

(57) ABSTRACT

Systems, methods and computer program products are disclosed for associating unique identifiers to files of a file system to indicate that the contents of the files have changed. In some implementations, a counter value associated with a file is incremented or decremented each time the file contents are changed. The unique identifier may be stored with the file contents and file metadata in the cache. When a process requests access to the cached file contents, the process requests the unique identifier from a system component and compares the unique identifier with the unique identifier returned by the system component. If the two unique identifiers are the same, the cached file contents are deemed valid and can be used by the process. If the two unique identifiers are different, the cached file contents are deemed invalid.

### TECHNICAL FIELD

This disclosure is related generally to computer file management systems.

### BACKGROUND

A computer file system is used to store, retrieve and update files. A file system manager provides access to data and metadata of files. File metadata may include the length of the data contained in a file, the time the file was last modified, the file creation time, the time the file was last accessed, the time the file metadata was changed, or the time the file was last backed up.

In many applications, it is desirable to know if the content of a file has changed without computing a checksum or other computation for the entire file. Conventionally, applications would look at the timestamp for the file to determine the time the file was last modified. However, file timestamps have a certain granularity, and unless that granularity is the same as the granularity of the central processing unit (CPU) clock, there can be a window of time where multiple changes may occur during the same unit of time (e.g., 1 second), thus preventing the application from distinguishing between the multiple changes. For example, if the timestamp was updated on an hourly basis, then any two changes that occur within one hour will appear to have occurred at the same time since both changes will have the same timestamp.

### SUMMARY

Systems, methods and computer program products are disclosed for associating unique identifiers to files of a file system to indicate that the contents of the files have changed. In some implementations, a counter value associated with a file is incremented or decremented each time the file contents are changed. The unique identifier may be stored with the file contents and file metadata in the cache. When a process requests access to the cached file contents, the process requests the unique identifier from a system component (e.g., a file management system or operating system kernel) and compares the unique identifier with the unique identifier returned by the system component. If the two unique identifiers are the same, the cached file contents are deemed valid and can be used by the process. If the two unique identifiers are different, the cached file contents are deemed invalid and the process will need to read the file from main memory, disk or other storage. In some implementations, the unique identifier may be a unique number, such as a universally unique identifier (UUID) that indicates that the contents of a corresponding cached file have changed.

Other implementations are directed to systems, computer program products, and computer-readable mediums.

Particular implementations disclosed herein provide one or more of the following advantages. Cached data validity is determined by associating a unique identifier with each file in a file system that indicates that the contents of the file have changed. Accordingly, the modification of file contents may be determined without having to compute a time consuming checksum or other computation on the file contents.

The details of the disclosed implementations are set forth in the accompanying drawings and the description below. Other features, objects, and advantages will be apparent from the description and drawings, and from the claims.

### DESCRIPTION OF DRAWINGS

FIG. 1 is a block diagram of an exemplary system for determining cached data validity.

FIG. 2 is a flow diagram of an exemplary process for determining cached data validity.

FIG. 3 is a block diagram of an exemplary computer system architecture for implementing cached data validity.

The same reference symbol used in various drawings indicates like elements.

### DETAILED DESCRIPTION

### Exemplary System

FIG. 1 is a block diagram of an exemplary system 100 for determining cached data validity. In some implementations, system 100 may include computing device 101, which may be coupled to local and remote storage devices 112, 116. Computing device 101 may be a personal computer, smart phone, electronic tablet or any other device that stores file contents in cache memory and that needs to know whether the contents have changed. An example operating system is Mac OS®, developed by Apple Inc. of Cupertino, Calif., USA.

Computing device 101 may include operating system kernel 102, file system manager 104 (FSM), cached data 106, application(s) 108 and input/output (I/O) interface 110. I/O interface 110 may be coupled to local storage device 112 and remote storage device 116 through network 114 (e.g., wide area network (WAN)).

Operating system kernel 102 may be any known operating system (e.g., Mac OS®, Windows®, Linux). Operating system kernel 102 may be multi-user, multiprocessing, multitasking, multithreading, real-time and the like. The operating system performs basic tasks, including but not limited to: keeping track of files and directories on storage devices 112, 114, which may be controlled directly or through I/O interface 110 (e.g., a I/O controller); and managing traffic on communication channels over network 114.

FSM 104 is a computer program that provides a user interface to work with file systems. FSM 104 may perform operations on files or groups of files stored on devices 112, 116, including but not limited to the following operations: create, open, edit, view, print, play, rename, move, copy, delete, search/find, and modify file attributes, properties and file permissions. An example file system manager is Finder®, which is part of the Mac OS® operating system, developed by Apple Inc. FSM 104 may display files in a hierarchy in a user interface and include navigational elements (e.g., buttons) for allowing the user to navigate and select the files. FSM 104 may provide network connectivity using protocols, such as File Transfer Protocol (FTP), Network File System (NFS), Server Message Block (SMB) or Web Distributed Authoring and Versioning (WebDAV).

Cached data 106 may include file contents and file metadata. In the example shown, an inode number/unique ID pair is stored as metadata for each file in storage devices 112, 116. An inode (index node) is a data structure found in many UNIX file systems that stores information about a file system object (e.g., a file or a portion of a file).

### Exemplary Process

FIG. 2 is a flow diagram of an exemplary process 200 for determining cached data validity. Process 200 may be performed using computer system architecture 300, described in reference to FIG. 3.

In some implementations, process 200 may begin by obtaining a request to access file data stored in cache (202). For example, the request may be made by an application, file system manager or operating system kernel in a computer device.

Process 200 may continue by obtaining a unique identifier for the file data from the cache (204). In some implementations, the unique identifier is a counter value from a counter associated with the file that is incremented (or decremented) each time the file is changed. In other implementations, the unique identifier is a UUID. In some implementations, a data structure element for the file is obtained from cache together with the unique identifier, such as an inode number that uniquely identifies the file. The unique number may be based on or a combination of the UUID and the counter value.

Process 200 may continue by obtaining a unique identifier for the file from a system component (206). For example, the system component may be a file system manager, operating system kernel or system memory (e.g., main memory). In some implementations, file metadata is obtained from the system component together with the unique identifier. In UNIX systems, the file metadata may be an inode number obtained from an inode data structure for the file.

Process 200 may continue by comparing the unique identifier stored in cache with the unique identifier obtained from the system component (208) and determining whether the cached file contents are valid or invalid based on results of the comparing (210). For example, the unique identifier and file metadata (e.g., inode number) for the file that is stored in cache are compared with the unique identifier and file metadata for the file provided by the system component. If the unique identifiers and the file metadata match, then the cached data is valid. Otherwise, the cached data is invalid.

Whenever a file is changed in the file system, a unique identifier is associated with the changed file. In implementations that use inodes, inode numbers may also be compared to ensure that the correct files are being compared. The unique identifier may be stored with the inode number in the file metadata.

By way of example, an application may copy a file from system memory (e.g., main memory) or a hard disk into cache memory to be processed by the application. At this time, a unique identifier associated with the file is stored as metadata in cache memory with the file contents. In some implementations, an inode number is also stored in cache memory with the unique identifier. In some implementations, the unique number is a UUID or counter value.

During the processing by the application, another application or operating system may access the file in system memory (the original source of the file) and change the file contents. At that time, a new unique identifier is stored with the file in system memory. If a counter is used, the counter is incremented or decremented and the new counter value is stored in system memory with the file. The next time the application accesses the file in cache memory the unique identifier (and inode number) are compared with the unique identifier (and inode number) in system memory. If the unique identifier and inode number match, the cached data is deemed valid and can be used by application. If the unique identifier and inode number do not match, the cached data is deemed invalid and the application may fetch the file (with the changed contents) and the new unique identifier from system memory and store it in cache memory to be processed.

### Exemplary Computer System Architecture

FIG. 3 is a block diagram of an exemplary computer system architecture 300 for implementing. Architecture 300 may be implemented on any data processing apparatus that runs software applications derived from instructions, including without limitation personal computers, smart phones, electronic tablets, game consoles, servers or mainframe computers. In some implementations, the architecture 300 may include processor(s) 302, storage device(s) 304, network interfaces 306, Input/Output (I/O) devices 308 and computer-readable medium 310 (e.g., memory). Each of these components may be coupled by one or more communication channels 312.

Communication channels 312 may be any known internal or external bus technology, including but not limited to ISA, EISA, PCI, PCI Express, NuBus, USB, Serial ATA or FireWire.

Storage device(s) 304 may be any medium that participates in providing instructions to processor(s) 302 for execution, including without limitation, non-volatile storage media (e.g., optical disks, magnetic disks, flash drives, etc.) or volatile media (e.g., SDRAM, ROM, etc.).

I/O devices 308 may include displays (e.g., touch sensitive displays), keyboards, control devices (e.g., mouse, buttons, scroll wheel), loud speakers, audio jack for headphones, microphones and another device that may be used to input or output information.

Computer-readable medium 310 may include various instructions 314 for implementing an operating system (e.g., Mac OS®, Windows®, Linux). The operating system may be multi-user, multiprocessing, multitasking, multithreading, real-time and the like. The operating system performs basic tasks, including but not limited to: keeping track of files and directories on storage devices(s) 304; controlling peripheral devices, which may be controlled directly or through an I/O controller; and managing traffic on communication channels 312. In some implementations, the operating system includes file system manager 316 and OS kernel 318, as described in reference to FIG. 1. Computer-readable medium 310 may include cache memory 322 for storing file contents and file meta data (e.g., inode/Unique ID pair for the file), as described in reference to FIGS. 1 and 2.

Network communications instructions 320 may establish and maintain network connections with client devices (e.g., software for implementing transport protocols, such as TCP/IP, RTSP, MMS, ADTS, HTTP Live Streaming). Computer-readable medium 310 may store instructions, which, when executed by processor(s) 302 implement concept engine 106.

The features described may be implemented in digital electronic circuitry or in computer hardware, firmware, software, or in combinations of them. The features may be implemented in a computer program product tangibly embodied in an information carrier, e.g., in a machine-readable storage device, for execution by a programmable processor; and method steps may be performed by a programmable processor executing a program of instructions to perform functions of the described implementations by operating on input data and generating output.

The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer may communicate with mass storage devices for storing data files. These mass storage devices may include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with an author, the features may be implemented on a computer having a display device such as a CRT (cathode ray tube) or LCD (liquid crystal display) monitor for displaying information to the author and a keyboard and a pointing device such as a mouse or a trackball by which the author may provide input to the computer.

The features may be implemented in a computer system that includes a back-end component, such as a data server or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include a LAN, a WAN and the computers and networks forming the Internet.

The computer system may include clients and servers. A client and server are generally remote from each other and typically interact through a network. The relationship of client and server arises by virtue of computer programs running on the respective computers and having a client-server relationship to each other.

One or more features or steps of the disclosed embodiments may be implemented using an Application Programming Interface (API). For example, the data access daemon may be accessed by another application (e.g., a notes application) using an API. An API may define on or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

A number of implementations have been described. Nevertheless, it will be understood that various modifications may be made. Elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
receiving request to access file data of a file stored in cache memory;
obtaining a first unique identifier for the file from cached memory;
obtaining a second unique identifier for the file from a system component;
comparing the first and second unique identifiers; and
determining whether the stored file data is valid or invalid based on results of the comparing,
where the method is performed by one or more hardware processors.

2. The method of claim 1, where the unique identifier is a universally unique identifier (UUID).

3. The method of claim 1, where the unique identifier is a counter value that is incremented or decremented each time the file data is changed.

4. The method of claim 1, where the unique identifier is stored with file metadata.

5. The method of claim 1, where the system component is a file management system, operating system kernel or system memory.

6. The method of claim 1, further comprising:
obtaining a first data structure element for the file from cache memory;
obtaining a second data structure element for the file from the system component;
comparing the first and second data structures elements; and
determining whether the stored file data is valid or invalid based on results of the comparing of the unique identifiers and the data structure elements.

7. The method of claim 6, where the data structure element is an inode number.

8. The method of claim 7, where the unique identifier is a universally unique identifier (UUID).

9. The method of claim 7, where the unique identifier is a counter value that is incremented or decremented each time the file data is changed.

10. The method of claim 7, where the system component is a file management system, operating system kernel or system memory.

11. A system comprising:
one or more processors;
memory storing instructions, which, when executed by the one or more processors, causes the one or more processors to perform operations comprising:
receiving request to access file data of a file stored in cache memory;
obtaining a first unique identifier for the file from cache memory;
obtaining a second unique identifier for the file from a system component;
comparing the first and second unique identifiers; and
determining whether the stored file data is valid or invalid based on results of the comparing.

12. The system of claim 11, where the unique identifier is a universally unique identifier (UUID).

13. The system of claim 11, where the unique identifier is a counter value that is incremented or decremented each time the file data is changed.

14. The system of claim 11, where the unique identifier is stored with file metadata.

15. The system of claim 11, where the system component is a file management system, operating system kernel or system memory.

16. The system of claim 11, further comprising:
obtaining a first data structure element for the file from cache memory;
obtaining a second data structure element for the file from the system component;
comparing the first and second data structures elements; and
determining whether the stored file data is valid or invalid based on results of the comparing of the unique identifiers and the data structure elements.

17. The system of claim 16, where the data structure element is an inode number.

18. The system of claim 17, where the unique identifier is a universally unique identifier (UUID).

19. The system of claim 17, where the unique identifier is a counter value that is incremented or decremented each time the file data is changed.

20. The system of claim 17, where the system component is a file management system, operating system kernel or system memory.
